(19) United States
(12) Patent Application Publication
(10) Pub. No.: US 2021/0107126 A1
(43) Pub. Date: Apr. 15, 2021

(54) POWERED FASTENING DEVICE WITH COLLATION TEAR SAFETY SWITCH

(71) Applicant: Klein Tools, Inc., Lincolnshire, IL (US)

(72) Inventors: Zachary Carlins, Chicago, IL (US); John H. Kargenian, Prospect Heights, IL (US)

(73) Assignee: Klein Tools, Inc., Lincolnshire, IL (US)

(21) Appl. No.: 16/653,408

(22) Filed: Oct. 15, 2019

(51) Int. Cl. B25C 5/16; B25C 5/15

(52) U.S. Cl. CPC B25C 5/1665; F16B 15/08; B25C 5/1617; B25C 5/15

(57) ABSTRACT

A powered fastening device is capable of driving a fastener into a work piece and automatically preventing the device from firing until a fastener is located in an appropriate position within the device.

### CROSS-REFERENCE TO RELATED APPLICATIONS

None

### BACKGROUND OF THE DISCLOSURE

The present disclosure relates to tools, and, more particularly, to powered tools for driving staples or similar fasteners.

Powered fastening devices for driving staples or similar fasteners are known, including for driving heavy-duty utility fasteners in the forms of staples or similar fasteners. Such devices are powered in a variety of ways, including gas-powered, hydraulic powered, pneumatically powered, and electric powered by either a power cord or battery. Such devices concentrate force onto a striking member that drives a fastener into a work piece. Depending upon the power of the fastening device, the type and configuration of fastener, and the material of the work piece, a single driving stroke is typically sufficient to drive a fastener to a desired depth in a work piece for common applications, but in the field of heavy-duty utility fastening it is more difficult to drive the fastener to a desired depth with a single strike. Furthermore, it is difficult to control the depth to which the fastener is driven with a single strike.

In the electrical utility field, it is common to affix cables, wires and/or plastic moldings/wire protectors with large staples driven into utility poles and other structural members of an electrical distribution system, often in remote locations where standard 110-volt power sources are unavailable. Currently, the preferred method of accomplishing this task in the electrical utility field is to use a common hammer to drive U-shaped nails or staples into the structural members, which is a time consuming and often difficult process because of the likelihood of a mishit or deformation of the staple when attempting to strike the rounded surface of the staple with the hammer. The task is even more complicated by the desire to avoid pinching or crushing a cable or wire between a fastener and a utility pole or other structure when driving the fastener into the structure. Accordingly, there is a continuing need for improved fastening methods and devices to affix cables or wires to utility poles and other structural members.

U.S. patent application Ser. No. 16/405,381 filed on May 7, 2019 and naming John Kargenian et. al. as inventors (the entire disclosure of which is incorporated herein by reference) discloses a response to the above identified need in the form of a powered fastening device that is capable of multiple strikes to drive a fastener into a work piece while controlling the depth to which the fastener is driven so as to avoid pinching or crushing a cable or wire that is being joined to a structure by the fastener. While the disclosed device provides significant advantages, there is always room for improvement.

For example, in many powered fastening devices, in order to drive a fastener, such as a staple, the user must push the fastener feeder assembly against the work surface to enable the motor, but this action doesn't reduce the possibility of jams by separating a staple from a collation of staples and/or forcing the staple against the work surface prior to striking the staple.

### BRIEF SUMMARY OF THE DISCLOSURE

In accordance with one feature of this disclosure, a powered fastening device includes a main housing, a fastener drive assembly, a drive motor, and a motor control. The fastener drive assembly is carried in the main housing to drive a fastener into a work piece along a drive axis. The drive motor is carried in the main housing and operably connected to the fastener drive assembly to actuate the fastener drive assembly. The feeder assembly is configured to carry a joined collation of fasteners and to sequentially locate each fastener of the collation in a loaded position to be freed from the collation and moved to a ready position. The feeder assembly is mounted to the main housing to translate along the drive axis relative to the fastener drive assembly between a fastener load position wherein a fastener attached to the collation can be moved to the loaded position and a fastener drive position wherein the fastener has been freed from the collation and moved to the ready position to be driven by the fastener drive assembly into a work piece. The motor control is operably connected to the drive motor and configured to disable the drive motor until the feeder assembly moves from the fastener load position to the fastener drive position.

As one feature, the motor control includes a user actuated trigger switch, and the motor control is configured to enable the drive motor in response to user actuation of the trigger switch with the feeder assembly in the fastener drive position.

In one feature, the motor control further includes a mechanically actuated switch, the switch having a first condition wherein the drive motor is disabled and a second condition wherein the drive motor is enabled. The powered fastening device includes a switch-actuating member located to actuate the mechanically actuated switch to the second condition with the feeder assembly in the fastener drive position.

According to one feature, the mechanically actuated switch is fixed on the feeder assembly, and the switch-actuating member is fixed to main housing.

As one feature, the mechanically actuated switch includes a switch body and an input member mounted on the switch body to move between an unactuated position and an actuated position. The mechanically actuated switch changes from one of the first and second conditions to the other of the first and second conditions in response to the input member moving from the unactuated position to the actuated position. In a further feature, the input member is pivot mounted to the switch body and includes a surface that is engaged by the switch-actuating member with the feeder assembly in the fastener drive position.

According to one feature, the drive motor is an electric motor and the device further includes a battery operably connected to the motor control to selectively energize the drive motor.

In one feature, the fastener drive assembly includes a drive pin mounted to translate relative to the main housing to strike a fastener positioned in the feeder assembly to drive the fastener into a work piece. The drive motor is operable connected to the fastener drive assembly by a percussive assembly configured to repeatedly strike the drive pin.

As one feature, the feeder assembly includes a fastener magazine configured to carry the plurality of fasteners, and a fastener nozzle configured to sequentially receive individual fasteners from the magazine in the loaded position.

In accordance with one feature of this disclosure, a powered fastening device includes a main housing, a fastener drive assembly, a drive motor, a mechanically actuated switch, and a switch-actuating member. The fastener drive assembly is carried in the main housing to drive a fastener into a work piece along a drive axis. The drive motor is carried in the main housing and operably connected to the fastener drive assembly to actuate the fastener drive assembly. The feeder assembly is configured to carry a joined collation of fasteners and to sequentially locate each fastener of the collation in a loaded position to be freed from the collation and moved to a ready position. The feeder assembly is mounted to the main housing to translate along the drive axis relative to the fastener drive assembly between a fastener load position wherein a fastener attached to the collation can be moved to the loaded position and a fastener drive position wherein the fastener has been freed from the collation and moved to the ready position to be driven by the fastener drive assembly into a work piece. The mechanically actuated switch is operably connected to the drive motor and has a first condition wherein the drive motor is disabled and a second condition wherein the drive motor is enabled. The switch-actuating member is located to actuate the mechanically actuated switch to the second condition in response to the feeder assembly translating to the fastener drive position.

In one feature, the mechanically actuated switch is fixed on the feeder assembly, and the switch-actuating member is fixed to fastener drive assembly.

According to one feature, the mechanically actuated switch includes a switch body and an input member mounted on the switch body to move between an unactuated position and an actuated position. The mechanically actuated switch changes from one of the first and second conditions to the other of the first and second conditions in response to the input member moving from the unactuated position to the actuated position. In a further feature, the input member is pivot mounted to the switch body and includes a surface that is engaged by the switch-actuating member with the feeder assembly in the fastener drive position.

As one feature, the device further includes a user actuated trigger switch operably connected to the drive motor to enable the drive motor in response to user actuation of the trigger switch with the feeder assembly in the fastener drive position.

In one feature, the drive motor is an electric motor and the device further includes a battery operably connected to the drive motor to selectively energize the drive motor.

According to one feature, the fastener drive assembly includes a drive pin mounted to translate relative to the main housing to strike a fastener positioned in the feeder assembly to drive the fastener into a work piece; and the drive motor is operable connected to the fastener drive assembly by a percussive assembly configured to repeatedly strike the drive pin.

As one feature, wherein the feeder assembly includes a fastener magazine configured to carry the plurality of fasteners, and a fastener nozzle configured to sequentially receive individual fasteners from the magazine in the loaded position.

In accordance with one feature of this disclosure, a powered fastening device includes a main housing, a fastener drive assembly, a drive motor, and a motor control. The fastener drive assembly is carried in the main housing to drive a fastener into a work piece along a drive axis. The drive motor is carried in the main housing and operably connected to the fastener drive assembly to actuate the fastener drive assembly. The feeder assembly is configured to carry a joined collation of fasteners and to sequentially locate each fastener of the collation in a loaded position to be freed from the collation and moved to a ready position. The feeder assembly is mounted to the main housing to translate along the drive axis relative to the fastener drive assembly between a fastener load position wherein a fastener attached to the collation can be moved to the loaded position and a fastener drive position wherein the fastener has been freed from the collation and moved to the ready position to be driven by the fastener drive assembly into a work piece. The motor control is operably connected to the drive motor and configured to disable the drive motor until a fastener is in the ready position.

As one feature, the motor control is configured to disable the drive motor until the feeder assembly is in the fastener drive position. In a further feature, the motor control further includes a mechanically actuated switch having a first condition wherein the drive motor is disabled and a second condition wherein the drive motor is enabled; and the powered fastening device includes a switch-actuating member located to actuate the switch to the second condition with the feeder assembly in the fastener drive position.

It should be understood that the inventive concepts disclosed herein do not require each of the features discussed above, may include any combination of the features discussed above, and may include features not specifically discussed above.

### BRIEF SUMMARY OF THE SEVERAL VIEWS OF THE DRAWINGS

FIG. 1 is a perspective view from below and to the front/left of a powered fastening device according to this disclosure;

FIG. 2, is a longitudinal cross-section of the fastening device of FIG. 1, showing a fastener feeder assemble in an initial or start position;

FIG. 3 is a partial view similar to FIG. 2, but showing the fastener feeder assembly in a stop position with a fastener driven to less than a desired depth in a work piece;

FIG. 4 is a view similar to FIG. 3 but showing the fastener driven fully to the desired depth in a work piece;

FIG. 5 is a section view taken generally from line 5-5 in FIG. 2, but showing the feeder assembly in a different relative position that shown in FIG. 2;

FIG. 6 is an enlarged partial view of a portion of the device indicated by line 6-6 in FIG. 4;

FIG. 7 is a partial view similar to FIG. 3, but showing the fastener feeder assembly in a fastener load position with a fastener in a loaded position;

FIG. 8 is a partial view taken along line 8-8 in FIG. 7;

FIG. 9 is a partial view similar to FIG. 7, but showing the fastener feeder assembly in a fastener drive position with a fastener in a ready position; and

FIG. 10 is a partial view taken along line 10-10 in FIG. 9.

### DETAILED DESCRIPTION OF PREFERRED EMBODIMENTS

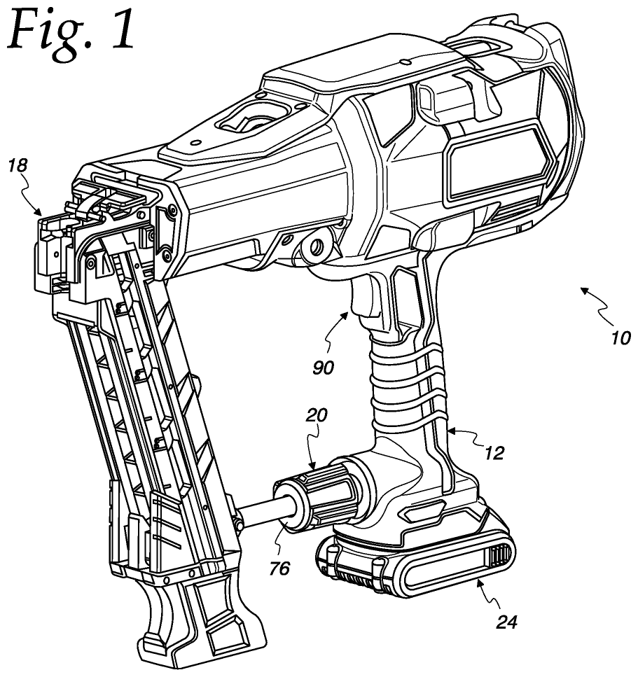

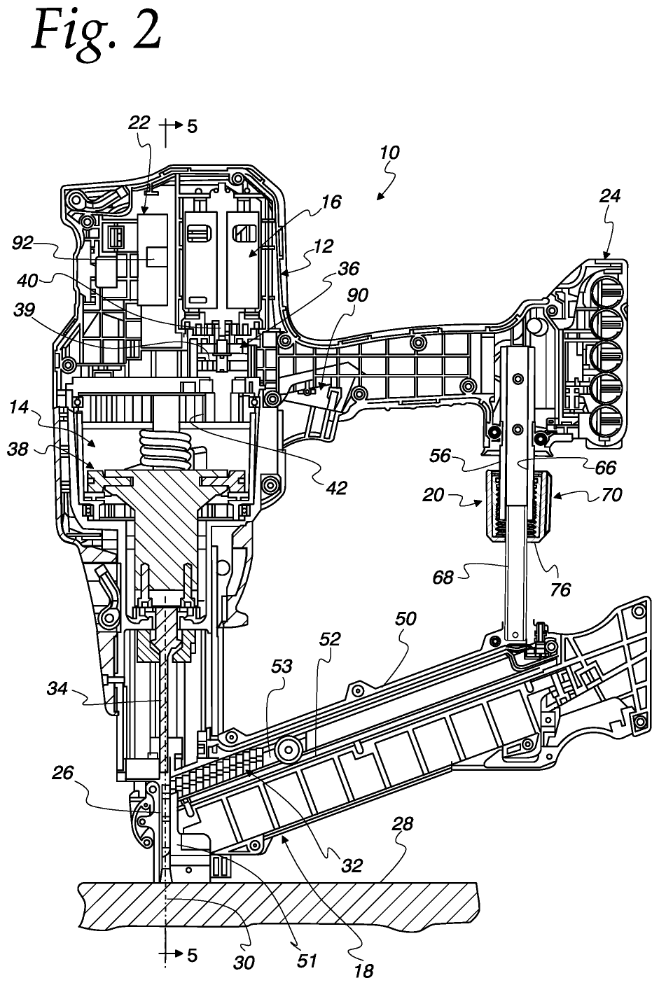

As best seen in FIGS. 1 and 2, a powered fastening device 10 is provided and is capable of applying multiple strikes to a fastener to drive the fastener to a preselected depth in a work piece. As best seen in FIG. 2, the fastening device 10 in the illustrated embodiment is a battery powered, heavy duty/utility staple driver and the device 10 includes a main housing 12, a fastener drive assembly 14, a drive motor 16, a fastener feeder assembly 18, an adjustable depth selector 20, and a motor control shown diagrammatically at 22 but having components mounted at several different locations in the device 10. In the illustrated and preferred embodiment, the drive motor 16 is a brushed dc electric motor 16 and the device 10 includes a power supply in the form of a rechargeable battery 24 operably connected to the motor 16 via the motor control 22. The rechargeable battery 24 is releasably connected to the housing 12 and may be of any suitable configuration, many of which are known.

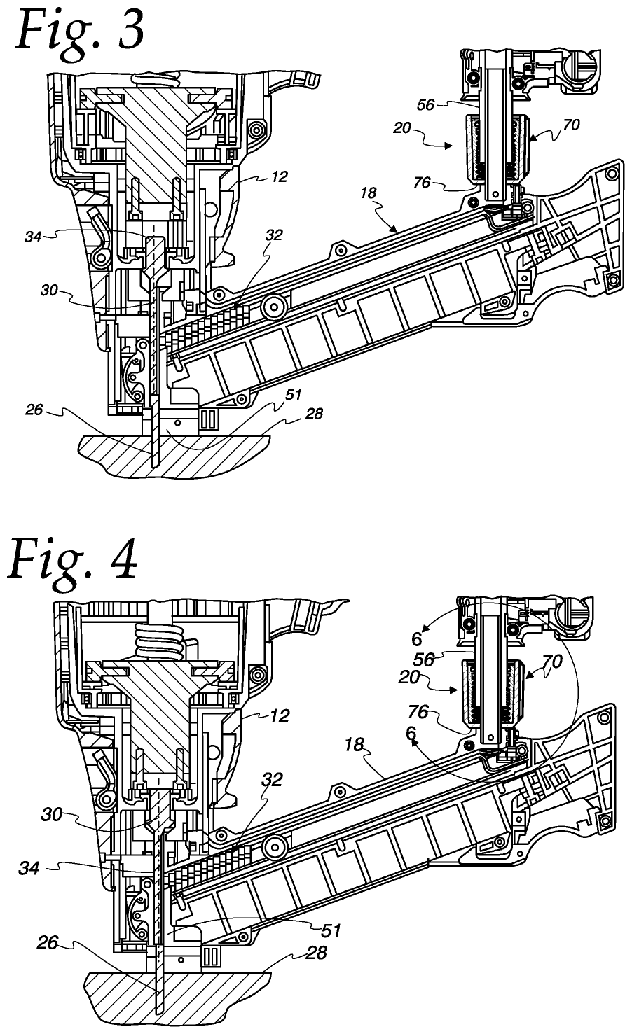

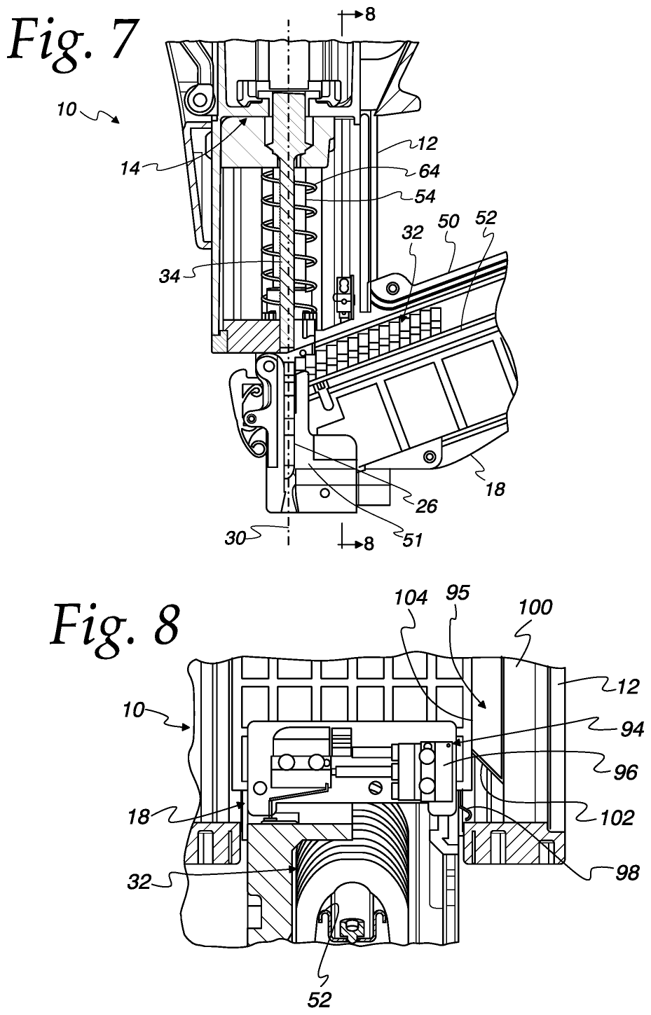

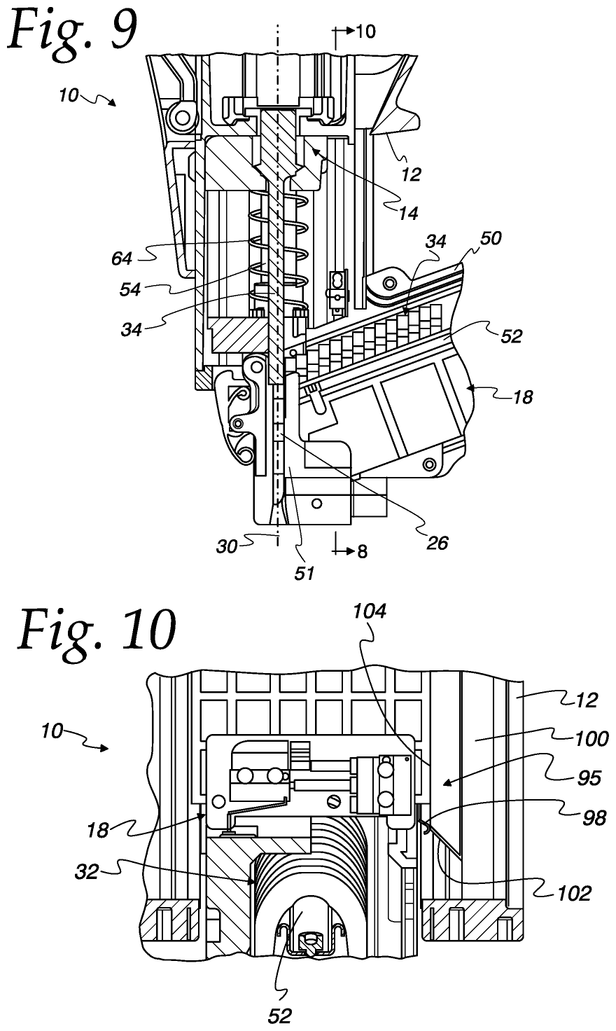

The fastener drive assembly 14 is carried in the housing 12 to drive a fastener 26 into a work piece 28 along a drive axis 30. The drive motor 16 is carried in the housing 12 and operably connected to the fastener drive assembly 14 to actuate the fastener drive assembly 14. The feeder assembly 18 is configured to carry a joined collation 32 of fasteners 26 and to sequentially position/locate each fastener 26 relative to the fastener drive assembly 14 in a loaded position where the fastener 26 can be freed from the collation 32 and moved to a ready position where the fastener 26 can be driven by the fastener drive assembly 14 into the work piece 28. The feeder assembly 18 is mounted to the housing 12 to translate along the drive axis 30 relative to the fastener drive assembly 14 between a fastener load position (shown in FIGS. 1, 2 and 7) and a fastener drive position (shown in FIGS. 9 and 10) prior to driving a fastener 26 into the work piece 28. In this regard, while driving a fastener 26 into a work piece 28, the feeder assembly translates along the drive axis 30 relative to the fastener drive assembly from the fastener drive position to a stop position (shown in FIGS. 3 and 4) where the fastener 26 has been driven to a desired depth into the work piece 28. As best seen in FIG. 7, in the fastener load position, a fastener 26 attached to the front of the collation 32 is moved to the loaded position. As best seen in FIG. 9, in the fastener drive position, the fastener 26 has been freed from the collation 32 while being forced to the ready position to be driven by the fastener drive assembly 14 into a work piece 28. The adjustable depth selector 20 is carried between the housing 12 and the feeder assembly 18 to selectively adjust the location of the stop position along the drive axis 30 to control how deep a fastener 26 from the feeder assembly 18 can be driven into the work piece 28 by the fastener drive assembly 14. As will be explained in greater detail below, the motor control 22 is operably connected to the drive motor 16 and is configured to disable the drive motor 16 until a fastener 26 has been moved to the ready position.

In the illustrated embodiment, the fastener drive assembly 14 includes a drive pin or punch 34 mounted to reciprocate relative to the housing 12 and the feeder assembly 18 along the drive axis 30 to strike a fastener 26 positioned in the feeder assembly 14 to drive the fastener 26 into the work piece 28. The drive motor 16 is operably coupled to the drive pin 34 by a gear train 36 and a percussive assembly 38. In the illustrated embodiment, the gear train 36 includes a planetary gear system 39 that transfers a drive torque from an output shaft 40 of the motor 16 to an input gear 42 of the percussive assembly 38. In response to the drive torque from the motor 16, the percussive assembly 38 is configured to strike the drive pin 34 at regular intervals to transfer an impact energy at each interval that drives the fastener 26 into the work piece 28. Further details of the illustrated and preferred configuration for the drive motor 16, gear train 36, and percussive assembly 38 are shown and described in FIGS. 3-7 and paragraphs [0034]-[0046] of U.S. patent application Ser. No. 16/192,379 filed Nov. 15, 2018 naming Kargenian et al. as inventor, the entire disclosure of which is incorporated herein by reference. While one preferred configuration is shown herein, it should be understood that any suitable drive motor 16, gear train 36, and/or percussive assembly 38 can be utilized with the inventive concepts disclosed herein; that the details of these components are not critical to understanding those inventive concepts; and that no limitation to any specific form or configuration for a percussive assembly is intended unless expressly recited in an appended claim. In this regard, some other examples of suitable drive motors, gear trains, and percussive assemblies are shown in the aforementioned and incorporated U.S. patent application Ser. Nos. 16/405,381 and 16/192,379.

As best seen in FIG. 2, the feeder assembly 18 includes a fastener magazine 50 and a fastener nozzle 51. The fastener magazine 50 is configured to carry the collation 32 of fasteners 26 and to sequentially load the fasteners 26 into the fastener nozzle 51. In this regard, the magazine 50 includes an elongate guide track 52 that guides the collation 32 toward the nozzle 51 and a spring biased ram 53 that pushes the collation 32 into the nozzle 51, as is known for many common staplers and staple guns. The fastener nozzle 51 is configured to sequentially receive individual fasteners 26 from the magazine 50 and to sequentially position each fastener 26 relative to the fastener drive assembly 14 to be driven into a work piece 28 by the fastener drive assembly 14. It should be understood that while a preferred embodiment is shown and described herein, the inventive concepts of this disclosure do not depend on the specific form, configuration, or construction of the feeder assembly 18 and any suitable form, construction, or configuration, many of which are known, can be used for the feeder assembly 18 to sequentially position a fastener, including fasteners other than staples, relative to the fastener drive assembly 14 to allow the drive assembly 14 to drive the fastener into a work piece.

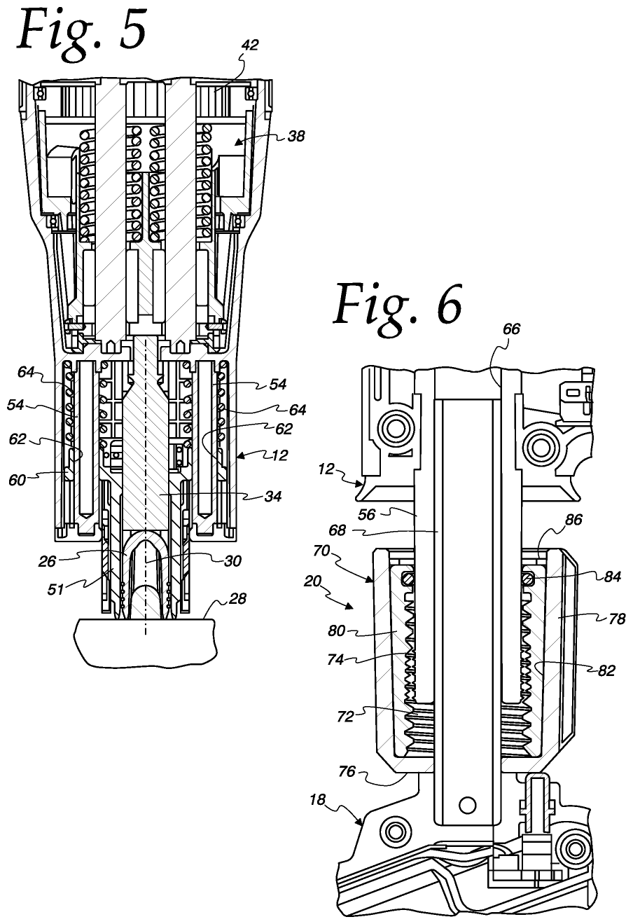

In the illustrated and preferred embodiment, the feeder assembly 18 is mounted to the main housing 12 by a pair of elongate, cylindrical guide rails 54 located adjacent the front of the device 10 and an elongate, cylindrical guide rail 56 located adjacent the rear of the device 10, as best seen in FIGS. 2 and 5. As best seen in FIG. 5, the rails 54 are identical to each other and are fixed in the main housing 12. The feeder assembly 18 includes a carriage 60 defining the fastener nozzle 51 and having a pair of guide bores 62, each sized to slidably receive the corresponding rail 54 for guided translation of the carriage 60 and the feeder assembly 18 parallel to the drive axis 30 relative to the main housing 12 and the fastener drive assembly 14. A pair of helical compression springs 64 are located between the carriage 60 and the main housing 12 to bias the feeder assembly 18 away from the main housing 12 and the drive assembly 14, with each of the springs 64 extending concentrically over one of the rails 54. As best seen in FIG. 2, the rail 56 is fixed in the housing 12 and has a cylindrical bore 66 that slidably receives an elongate, cylindrical guide rail 68 that is fixed to the feeder assembly 18 for guided translation of the feeder assembly 18 parallel to the drive axis 30 relative to the main housing 12 and the fastener drive assembly 14.

As best seen in FIG. 6, in the illustrated embodiment, the adjustable depth selector 20 includes a rotatable knob unit 70 that surrounds the rail 56 and has internal screw threads 72 that are engaged with external screw thread 74 on the rail 56. The interaction of the threads 72 and 74 allow a user to adjust the relative position between the knob unit 70 and the rail 56 and housing 12 by rotating the knob unit 70 either clockwise or counterclockwise. As best seen in FIGS. 3, 4, and 6, in the stop position, a distal end 76 of the knob unit 70 abuts the feeder assembly 18 to limit the translation of the feeder assembly 18 relative to housing 12 and the drive assembly 14 along the drive axis 30, which in turn controls the depth to which a fastener 26 is driven into the work piece 28. In the illustrated embodiment, the knob unit 70 includes an outer knob 78 and a threaded insert 80 that is received within an open recess 82 of the knob 78, with the threaded insert 80 and the recess 82 having conforming shapes that prevent rotation of the insert 80 relative to the knob 78. An O-ring 84 is mounted in the insert 80 and compressed between the insert 80 and the exterior of the rail 56 to provide a frictional engagement that resists undesired rotation of the knob unit 70 relative to the rail 56 due to vibration while a fastener 26 is being driven into the work piece 28 by the device 10. A snap ring 86 is engaged in the knob 78 to retain the insert 80 in the recess 82. The rails 54, 56, and 68, the carriage 60, and the threaded insert 80 are preferably made from a suitable steel or other metal, and the outer knob 78 is preferably molded from a suitable polymeric or composite material.

As best seen in FIG. 2, in the illustrated and preferred embodiment, the motor control 22 includes a user actuated trigger switch 90 and the motor control 22 is configured to energize the drive motor 16 in response to user actuation of the trigger switch 90, as is known. As previously mentioned, the motor control 22 is configured to disable the drive motor 16 until a fastener 26 has been moved to the ready position. To achieve this feature, in the illustrated embodiment, the motor control 22 is configured to disable the motor 16 until a user forces the feeder assembly 18 to the fastener drive position shown in FIGS. 9 and 10. In this regard, in the illustrated embodiment, the motor control 22 also includes a microprocessor or microcontroller 92 (shown diagrammatically in FIG. 2) operably connected to the motor 16 and a mechanically actuated switch 94 (shown in FIGS. 8 and 10). The microcontroller 92 can be of any suitable type of computing process unit and is mounted on a printed circuity board with any required supporting electronic components, such as memory, many of which are known to those skilled in the art. The switch 94 has a first condition, shown in FIGS. 7 and 8, wherein the drive motor 16 is disabled and a second condition, shown in FIGS. 9 and 10, wherein the drive motor 16 is enabled. The device 10 includes a switch-actuating member 95 located to actuate the switch 94 to the second condition, as shown in FIG. 10, with the feeder assembly 18 in the fastener drive position and to maintain the switch 94 in the second condition as a fastener 26 is driven from the ready position to a desired depth in a work piece 28. In the first condition, the switch 94 signals the microcontroller 92 to disable the motor 16 regardless of whether or not the trigger switch 90 is signaling that the motor 16 should be energized. In the second condition, the switch 94 signals the microcontroller 92 to enable the motor 16, which allows the motor 16 to energize in response to user actuation of the trigger switch 90. In some embodiments, if the user has actuated the trigger switch 90 before the switch 94 signals the microcontroller 92 to enable the motor 16, the microcontroller 92 will not enable the motor 16 until the trigger switch 90 has been released and reactuated by the user. These features helps prevent accidental firing of the device 10, which can potentially cause injury to a user or others, and jamming of the device 10 because a fastener 26 is not in the proper position prior to firing of the device 10. While the illustrated embodiment is preferred, in some applications it may be desirable for the motor control 22 to provide the feature with a different configuration. For example, rather than providing a signal to a microcontroller, the switch 94 could simply break the electrical connection between the motor 16 and the power supply 24 unless the switch 94 is placed in the second condition.

As best seen in FIGS. 8 and 10, in the illustrated and preferred embodiment, the switch 94 includes a switch body 96 and an input member 98 mounted to move (pivot) between an unactuated position (shown in FIG. 8) and an actuated position (shown in FIG. 10), with the input member 98 being biased to the unactuated position. The switch 94 changes from the first condition to the second condition in response to the input member 98 moving from the unactuated position to the actuated position. The switch 94 changes from the second condition to the first condition in response to the input member 98 moving from the actuated position to the unactuated position. In the illustrated embodiment, the switch body 96 is fixed to the feeder assembly 18 and the switch-actuating member 95 is in the form of a rib 100 formed on the main housing 12 adjacent the drive assembly 14. The rib 100 has a beveled end surface 102 that engages the input member 98 to actuate the member 98 from the unactuated position to the actuated position as the feeder assembly 18 is moved from the fastener load position to the fastener drive position, and a planar surface 104 that extends parallel to the drive axis 30 and maintains the input member 98 in the actuated position as a fastener 26 is driven from the ready position into a work piece 28

While the illustrated embodiment is preferred, it should be understood that in some embodiments, the device 10 could be configured so that the switch-actuating member 95 actuates the switch 94 from the second condition to the first condition with the feeder assembly 18 in the fastener drive position, with the motor control 22 being configured to enable the drive motor 16 with the switch 94 in the first condition and to disable the drive motor 16 with the switch 94 in the second condition.

Preferred embodiments of the inventive concepts are described herein, including the best mode known to the inventor(s) for carrying out the inventive concepts. Variations of those preferred embodiments will become apparent to those of ordinary skill in the art upon reading the foregoing description. The inventor(s) expect skilled artisans to employ such variations as appropriate, and the inventor(s) intend that the inventive concepts can be practiced otherwise than as specifically described herein. Accordingly, the inventive concepts disclosed herein include all modifications and equivalents of the subject matter recited in the claims appended hereto as permitted by applicable law. Moreover, any combination of the above-described elements and features in all possible variations thereof is encompassed by the inventive concepts unless otherwise indicated herein or otherwise clearly contradicted by context. Further in this regard, while highly preferred forms of the fastening device 10 are shown in the figures, it should be understood that this disclosure anticipates variations in the specific details of each of the disclosed components and features of the fastening device 10 and that no limitation to a specific form, configuration, or detail is intended unless expressly and specifically recited in an appended claim.

For example, while specific and preferred forms have been shown for the switches 90 and 94, any suitable form or configuration can be used. In this regard, for example, the switch 94 could be provided with an input member that translates between the unactuated and actuated conditions, rather than the pivoting input member 98 shown in the drawings. As a further example, the motor control 22 and switch 94 could be configured so that the switch 94 is in the second condition when the feeder assembly 18 is in the fastener drive position, with the motor 16 being disabled in response to the switch 94 being in the unactuated condition. As a further example, the drive motor 16 could be a brushless DC motor, rather than the brushed DC motor of the preferred embodiment. As another example, the power source could be an electrical cord that can be connected to an electrical outlet, rather than the battery 24 of the preferred embodiment. As yet another example, while the elongate rails 54, 56, and 68 are shown as cylindrical rails, other shapes or other methods of enabling the translation of the feeder assembly 18 may be desirable and employed with the inventive concepts disclosed herein. For example, other shapes and/or rollers or sliders could be utilized. Similarly, more or fewer of the rails 54, 56 and/or 68 may be desirable. In a further example, while the preferred embodiment includes the adjustable depth selector 20, in some embodiments it may be desirable for the device 10 to not include that feature. As a further example, while the knob unit 70 and engaged threads 72 and 74 are preferred, in some embodiments it may be desirable for an adjustable member to be provided in a different form and/or in a different location in the device 10. As yet another example, the switch 94 and switch-actuating member 95 could be located on other components of the device 10. For example, the switch 94 could be located on the main housing 12 and the switch-actuating member 95 could be located on the feeder assembly 18. In a further example, the switch 94 could be a non-mechanically actuated switch, such as a proximity switch or sensor. As an even further example, rather than using an electrical control such as the switch 94, the motor control 22 could employ a mechanical trigger block/lock that would prevent the trigger switch 90 from being actuated by a user, and thereby prevent the motor 16 from being enabled, until a user forces the feeder assembly 18 to the fastener drive position at which point an actuation linkage could move the trigger block/lock to a position/condition that would allow a user to actuate the trigger switch 90.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. The use of any and all examples, or exemplary language (e.g., “such as”) provided herein, is intended merely to better illuminate the inventive concepts disclosed herein and does not pose a limitation on the scope of any invention unless expressly claimed. No language in the specification should be construed as indicating any non-claimed element as essential to the practice of the inventive concepts disclosed herein.

All references, including publications, patent applications, and patents, cited herein are hereby incorporated by reference to the same extent as if each reference were individually and specifically indicated to be incorporated by reference and were set forth in its entirety herein.

Wat is claimed is:

1. A powered fastening device comprising:
a main housing;
a fastener drive assembly carried in the main housing to drive a fastener into a work piece along a drive axis;
a drive motor carried in the main housing and operably connected to the fastener drive assembly to actuate the fastener drive assembly;
a feeder assembly configured to carry a joined collation of fasteners and to sequentially locate each fastener of the collation in a loaded position to be freed from the collation and moved to a ready position, the feeder assembly mounted to the main housing to translate along the drive axis relative to the fastener drive assembly between a fastener load position wherein a fastener attached to the collation can be moved to the loaded position and a fastener drive position wherein the fastener has been freed from the collation and moved to the ready position to be driven by the fastener drive assembly into a work piece;
a motor control operably connected to the drive motor and configured to disable the drive motor until the feeder assembly moves from the fastener load position to the fastener drive position.

2. The powered fastening device of claim 1 wherein the motor control comprises a user actuated trigger switch, the motor control configured to enable the drive motor in response to user actuation of the trigger switch with the feeder assembly in the fastener drive position.

3. The powered fastening device of claim 2 wherein:
the motor control further comprises a mechanically actuated switch, the switch having a first condition wherein the drive motor is disabled and a second condition wherein the drive motor is enabled; and
the powered fastening device comprises a switch-actuating member located to actuate the mechanically actuated switch to the second condition with the feeder assembly in the fastener drive position.

4. The powered fastening device of claim 3 wherein the mechanically actuated switch is fixed on the feeder assembly, and the switch-actuating member is fixed to main housing.

5. The powered fastening device of claim 4 wherein the mechanically actuated switch comprises a switch body and an input member mounted on the switch body to move between an unactuated position and an actuated position, the switch changing from one of the first and second conditions to the other of the first and second conditions in response to the input member moving from the unactuated position to the actuated position.

6. The powered fastening device of claim 5 wherein the input member is pivot mounted to the switch body and includes a surface that is engaged by the switch-actuating member with the feeder assembly in the fastener drive position.

7. The powered fastening device of claim 1 wherein the drive motor is an electric motor and the device further comprises a battery operably connected to the motor control to selectively energize the drive motor.

8. The powered fastening device of claim 1 wherein:
the fastener drive assembly comprises a drive pin mounted to translate relative to the main housing to strike a fastener positioned in the feeder assembly to drive the fastener into a work piece; and
the drive motor is operable connected to the fastener drive assembly by a percussive assembly configured to repeatedly strike the drive pin.

9. The powered fastening device of claim 1 wherein the feeder assembly comprises a fastener magazine configured to carry the plurality of fasteners, and a fastener nozzle configured to sequentially receive individual fasteners from the magazine in the loaded position.

10. A powered fastening device comprising:
a main housing;
a fastener drive assembly carried in the main housing to drive a fastener into a work piece along a drive axis;
a drive motor carried in the main housing and operably connected to the fastener drive assembly to actuate the fastener drive assembly;
a feeder assembly configured to carry a joined collation of fasteners and to sequentially locate each fastener of the collation in a loaded position to be freed from the collation and moved to a ready position, the feeder assembly mounted to the main housing to translate along the drive axis relative to the fastener drive assembly between a fastener load position wherein a fastener attached to the collation can be moved to the loaded position and a fastener drive position wherein the fastener has been freed from the collation and moved to the ready position to be driven by the fastener drive assembly into a work piece;
a mechanically actuated switch operably connected to the drive motor, the mechanically actuated switch having a first condition wherein the drive motor is disabled and a second condition wherein the drive motor is enabled; and
a switch-actuating member located to actuate the mechanically actuated switch to the second condition in response to the feeder assembly translating to the fastener drive position.

11. The powered fastening device of claim 10 wherein the mechanically actuated switch is fixed on the feeder assembly, and the switch-actuating member is fixed to fastener drive assembly.

12. The powered fastening device of claim 10 wherein the mechanically actuated switch comprises a switch body and an input member mounted on the switch body to move between an unactuated position and an actuated position, the mechanically actuated switch changing from one of the first and second conditions to the other of the first and second conditions in response to the input member moving from the unactuated position to the actuated position.

13. The powered fastening device of claim 12 wherein the input member is pivot mounted to the switch body and includes a surface that is engaged by the switch-actuating member with the feeder assembly in the fastener drive position.

14. The powered fastening device of claim 10 further comprising a user actuated trigger switch operably connected to the drive motor to enable the drive motor in response to user actuation of the trigger switch with the feeder assembly in the fastener drive position.

15. The powered fastening device of claim 10 wherein the drive motor is an electric motor and the device further comprises a battery operably connected to the drive motor to selectively energize the drive motor.

16. The powered fastening device of claim 10 wherein:
the fastener drive assembly comprises a drive pin mounted to translate relative to the main housing to strike a fastener positioned in the feeder assembly to drive the fastener into a work piece; and
the drive motor is operable connected to the fastener drive assembly by a percussive assembly configured to repeatedly strike the drive pin.

17. The powered fastening device of claim 10 wherein the feeder assembly comprises a fastener magazine configured to carry the plurality of fasteners, and a fastener nozzle configured to sequentially receive individual fasteners from the magazine in the loaded position.

18. A powered fastening device comprising:
a main housing;
a fastener drive assembly carried in the housing to drive a fastener into a work piece along a drive axis;
a drive motor carried in the housing and operably connected to the fastener drive assembly to actuate the fastener drive assembly;
a feeder assembly configured to carry a joined collation of fasteners and to sequentially locate each fastener of the collation in a loaded position to be freed from the collation and moved to a ready position, the feeder assembly mounted to the main housing to translate along the drive axis relative to the fastener drive assembly between a fastener load position wherein a fastener attached to the collation can be moved to the loaded position and a fastener drive position wherein the fastener has been freed from the collation and moved to the ready position to be driven by the fastener drive assembly into a work piece;
a motor control operably connected to the drive motor and configured to disable the drive motor until a fastener is in the ready position.

19. The powered fastening device of claim 18 wherein the motor control is configured to disable the drive motor until the feeder assembly is in the fastener drive position.

20. The powered fastening device of claim 19 wherein:
the motor control further comprises a mechanically actuated switch, the switch having a first condition wherein the drive motor is disabled and a second condition wherein the drive motor is enabled; and
the powered fastening device comprises a switch-actuating member located to actuate the mechanically actuated switch to the second condition with the feeder assembly in the fastener drive position.
